(19) United States
(12) Patent Application Publication
(10) Pub. No.: US 2003/0208614 A1
(43) Pub. Date: Nov. 6, 2003

(54) System and method for enforcing system performance guarantees

(76) Inventor: John Wilkes, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/135,412

(22) Filed: May 1, 2002

(51) Int. Cl. G06F 15/16

(52) U.S. Cl. 709/232

(57) ABSTRACT

A method for enforcing system performance guarantees. The method includes receiving one or more requests for access to a target system, determining at least one performance related function to apply to the one or more requests, and forwarding the one or more requests to the target system in accordance with the at least one performance related function. The at least one performance related function may be determined based on at least one previously input specification and type of the target system.

### FIELD OF THE INVENTION

The invention is generally related to network based storage systems. More particularly, the invention is related to quality of service on network based storage systems.

### BACKGROUND OF THE INVENTION

As storage systems evolve, the demand for network storage systems is increasing. The increased demand for data storage in a network is typically met by using more storage servers in the network or by using storage servers of increased storage capacity and data transmission bandwidth. Thus, network-based interconnections between storage devices and their clients, such as host computers, have become more important.

Although the addition of network-based interconnections between storage devices and their clients increases the opportunity for sharing, the increased sharing also increases the opportunity for contention to exist. Despite the increase in contention, it is becoming increasingly important to be able to make performance guarantees to business-critical applications.

One approach to meeting the demand for performance guarantees is traffic shaping. Existing network-based traffic shapers typically count only packets/second or bytes/second. Since the cost of sending a set of packets is a relatively simple function of the number of packets and their aggregate length, measuring packet-volume (packet rate) works well in networking.

In storage devices, however, measuring performance is not so simple. For storage devices, different types of requests may have very different performance implications on the underlying device. For example, sequential reads may have different performance implications than random reads. Thus, performing traffic shaping based on packets/second or bytes/second may not be sufficient to guarantee performance in storage systems.

### SUMMARY OF THE INVENTION

A method for enforcing system performance guarantees. The method includes receiving one or more requests for access to a target system, determining at least one performance related function to apply to the one or more requests, and forwarding the one or more requests to the storage system in accordance with the at least one performance related function. The at least one performance related function may be determined based on at least one previously input specification.

### BRIEF DESCRIPTION OF THE DRAWINGS

The invention is illustrated by way of example and not limitation in the accompanying figures in which like numeral references refer to like elements, and wherein:

FIG. 1 illustrates a block diagram of an exemplary embodiment of a network including a system for enforcing target system performance guarantees;

FIGS. 2A-2C illustrate block diagrams of various exemplary embodiments of a quality of service unit;

FIG. 3 illustrates a graph of two exemplary utility functions used by the quality of service unit to improve target system performance;

FIG. 4 illustrates a flow diagram of an exemplary embodiment of a method for enforcing storage system performance guarantees; and

FIG. 5 illustrates a block diagram of an exemplary second embodiment of the system for enforcing storage system guarantees.

### DETAILED DESCRIPTION OF THE INVENTION

A system for enforcing system performance guarantees is described. The system may include a quality of service unit for enforcing system performance. In the following detailed description, numerous specific details are set forth in order to provide a thorough understanding of the invention. However, it will be apparent to one of ordinary skill in the art that these specific details need not be used to practice the invention. In other instances, well known structures, interfaces, and processes have not been shown in detail in order not to obscure unnecessarily the invention.

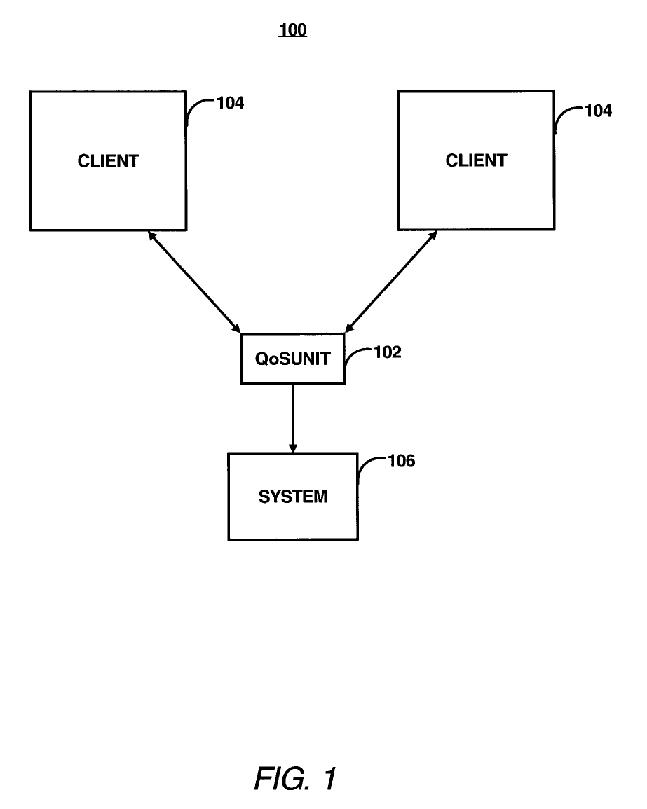

FIG. 1 is a block diagram illustrating one embodiment of a network arrangement 100 including enforcement of system performance guarantees. Network arrangement 100 may include at least one client system 104, a quality of service (“QoS”) unit 102, and a target system 106 to be protected. The client system(s) 104 may include a host computer or processing system, a disk array, a disk drive, a network element, a data mover, or any other component that may make requests to system 106. In one embodiment, the client system 104 may make requests to system 106 to perform system related functions. In one embodiment, a client system 104 may make request(s) to system 106 over a network (not shown).

Target system 106 may include any function that interacts with a client through a sequence of requests and responses and either stores or retrieves data or both; any system that performs this may be referred to as a “storage system”. For example, in one embodiment, system 106 may be a raw-storage system. The storage target system 106 may include one or more different types of storage systems. For example, in one embodiment, system 106 may include a storage disk drive, a removable disk drive, a disk array, a set of disk arrays, a collection of disks (sometimes called “just a bunch of disks”, or “JBOD”), a tape drive, a tape library, a “FLASH” memory unit or card, or any other storage device or combination of similar storage devices. In another embodiment, storage target system 106 may include a storage area network. In another embodiment, storage target system 106 may include a file server. In another embodiment, storage target system 106 may include a multimedia server, that attempts to deliver stored content according to an externally-imposed schedule (e.g., to meet the bandwidth requirements of a video or audio stream). In another embodiment, storage target system 106 may include a network file system including a local area network and a file server. In another embodiment, storage target system 106 may include a database, and may provide a database-access service.

In other embodiments, system 106 may offer another network-based service such as a web service, or other application service. For example, the system 106 may include a web-based search engine or other web site, or an information search service. In one embodiment, target system 106 may include one or more target system types of one or more of the kinds described above.

In one embodiment, the QoS unit 102 may intercept a request for access transmitted by a client 104 to system 106. The QoS unit 102 may be a box including software configured to perform traffic shaping function(s) on the request(s) for access received from client(s) 104. The QoS unit 102 may reside in existing components of a network arrangement 100. For example, the QoS unit 102 may exist inside client 104, in a fabric switch (not shown), in a disk array (not shown) or in a data mover (not shown). A data mover may include any component that moves data from one storage system to another storage system without transmitting the data to a client system first. In one embodiment, the QoS unit 102 may include functionality to perform data moving functions.

The QoS unit 102 may also be placed in a host bus adapter (“HBA”) or a RAID controller card. When the QoS unit 102 software is placed in other network components, the other network components may be adapted to host the QoS unit 102 software. The QoS unit software may be programmed into the other network components or downloaded into the other network components upon request or need.

The QoS unit 102 may appear to clients, such as client systems 104, as a set of virtual storage objects or logical units (“LUs”). The LUs may be mapped onto underlying storage LUs. Additional functions may be provided by the QoS unit 102. The additional functions may include LU aggregation, LU security and/or local or remote replication (“mirroring”), depending on the type of target system 106. The additional functions may also include one or more of request merging (two separate requests overlap in the information they include or request, and can be merged into one), request coalescing (two separate requests can be combined into one, larger one, in order to be handled more efficiently), and splitting or breaking up requests (a single request is divided up into two or more requests). Additional functions may be added or changed based on the nature of target system 106.

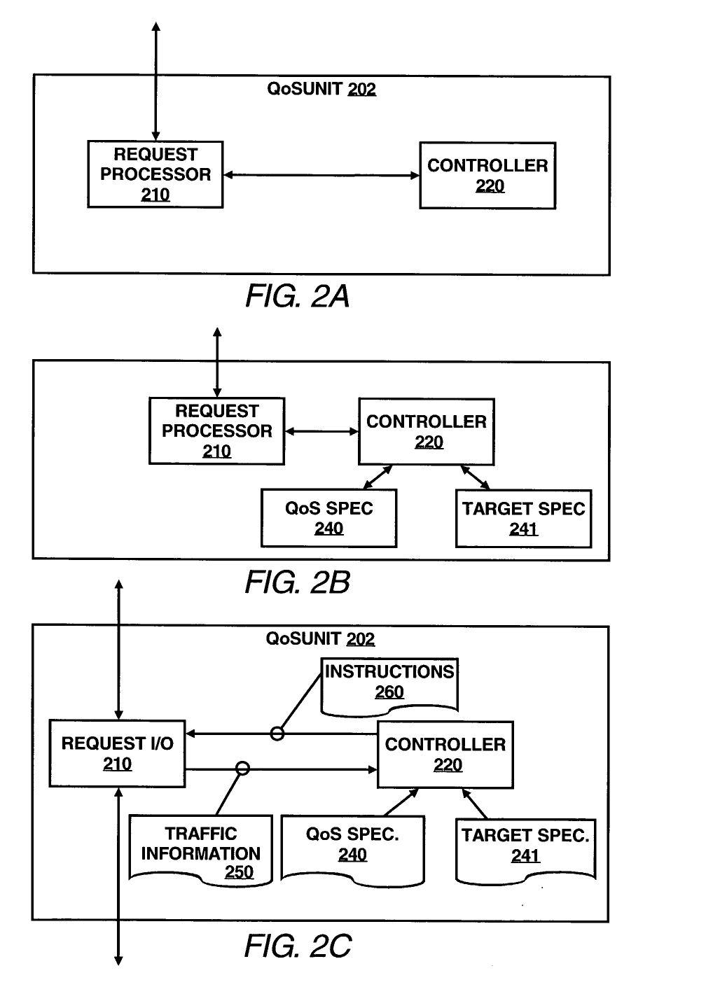

FIGS. 2A-C are block diagrams illustrating various embodiments of a QoS unit 202. QoS unit 202 may include request processing module 210 and controller 220, as shown in FIG. 2A.

Request processing module 210 may receive or intercept requests from client 104 and transmit the request to target system 106 after performing traffic shaping functions on the request. Requests may arrive at, and depart from, request processing module 210 in any manner. For example, requests may arrive on multiple links, or on the same link, and they may depart on the same link or links that they arrived on, or on a different link or links. In some embodiments, requests may be broken up, merged, or otherwise reconstituted on their way to the target system. For example, a single large read request may be broken into two smaller ones, so as to impose less load on the target system. In another embodiment, a sequence of small reads may be coalesced.

Controller 220 may determine performance enhancement functions that may be performed on the received requests. These functions may be based on input QoS specifications 240 or QoS goals, as shown in FIGS. 2B and 2C. QoS goals may be specified in any known way. An example of QoS specifications is described in John Wilkes, Traveling to Rome: QoS Specifications for Automated Storage System Management, Proc. Intl. Workshop on Quality of Service (IWQoS'2001) (Jun. 6-8, 2001, Karlsruhe, Germany), herein incorporated by reference in its entirety.

The QoS specifications may be applied by controller 220 to determine performance enhancement functions to apply to the input streams handled by request I/O module 210. In one embodiment, this performance enhancement may be done to bound or limit the rate at which the input streams interfere with each other. For example, controller 220 may determine traffic shaping functions to be performed on the received requests.

In one embodiment, controller 220 may determine traffic shaping instructions 260 that are obeyed by request processing module 210, as shown in FIG. 2C. The traffic shaping instructions may be based on predetermined parameters. The predetermined parameters may include traffic information 250, such as from which client 104 the request was received, the type of the request, the target system 106 or the subunit of the target system 106 to which the request is directed and the performance of the subunit of the target system 106 to which the request is directed. Those skilled in the art will recognize that there are many other possibilities, and combinations of these parameters may also be used, in nearly limitless ways.

In another embodiment, the controller 220 may include a performance model to provide the controller 220 guidance in how best to make traffic shaping decisions. The controller may determine changes to be made in the traffic and adjust the behavior of the traffic to be nearer to the targeted goal. One example of a performance model may be found in Mustafa Uysal et al., “A modular, analytical throughput model for modern disk arrays”, Proceedings of the Ninth International Symposium on Modeling, Analysis and Simulation of Computer and Telecommunications Systems (MASCOTS-2001), pp. 183-192, Aug. 15-18, 2001, herein incorporated by reference in its entirety.

In one embodiment, controller 220 may receive target performance goals and guarantees or target specification 241. The target specification 241 may include a target system description to be used by the controller 220 to make traffic shaping decisions. In one embodiment, the controller 220 may receive information regarding interactions between stored system requests and the storage device performance, either by explicit feedback from the target system 106, or from other monitoring tools, including, but not limited to, the request processing module 210.

The traffic shaping may include rate control or response throttling. Rate control may include changing the rate at which requests are forwarded until the rate at which the requests are forwarded reaches a predetermined level. Thus, the rate at which requests are processed by the system 106 is changed. This may improve the performance of the system 106 as perceived by at least some of its clients. For example, if a queue of requests has built up in the storage device, then the response time for a storage device may go up. If the rate at which requests are transmitted to the system 106 or subunits of the system 106 is controlled, the queue of system requests may build up less in the target system 106 and the response times may go down, including, perhaps, response times for requests directed to separate parts of the target system 106. However, instead of adjusting the rate based on a fixed target request rate, controller 220 may determine the rate based on the time it takes to respond to the request instead, or using a combination of these methods.

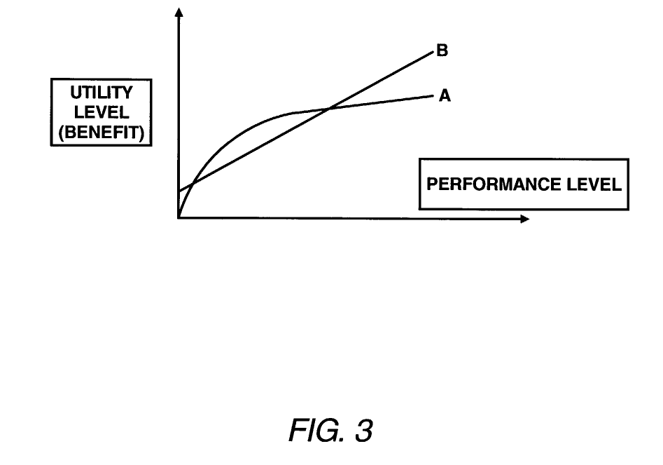

The module 220 may make its decisions in order to increase the overall benefit to the uses or clients of the target system, or it may make its decisions in order to preferentially benefit particular uses or clients. For example, it may use utility functions, which describe how much benefit results from a given level of performance, to make tradeoffs between different uses. For example, in the graph of FIG. 3, two utility functions are shown: A and B. If the offered load corresponding to the B load increases, then it is beneficial to increase the performance for the B load. However, if the offered load for the A load is at a very low level (e.g., 0), then it is better to increase the A load's performance at the expense of the B load's at first. After a while, the reverse becomes true.

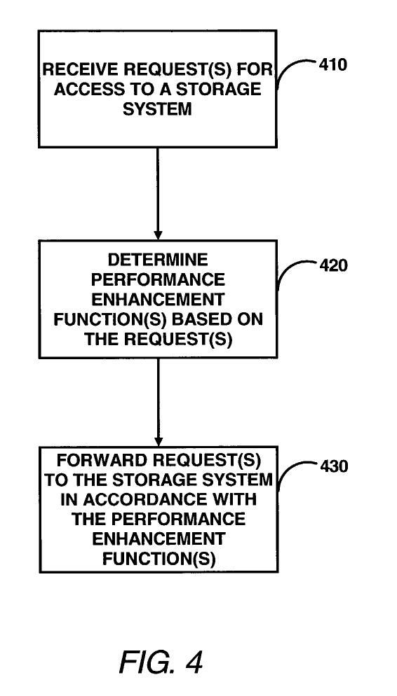

FIG. 4 is a flow diagram illustrating one embodiment of a method for enforcing storage system guarantees. At step 410, the request processing module 210 may receive requests for access to a target system 106.

Operations that may be performed on traffic include: deferring requests, dropping or discarding requests, and diverting requests, which may include sending requests to one or more different back-end service instances (e.g., storage devices) that may better service them. Diverting requests is also known as load balancing (or load leveling).

If a deferring requests function is performed on the traffic, the requests may be deferred until a less-loaded time, or merely to reduce the rate at which the requests come into the system. Dropping or discarding requests is usually not recommended in storage systems, although this technique is used in networks.

At step 420, the controller 220 may determine at least one performance enhancement function to apply to the requests. In one embodiment, determining at least one performance enhancement function may include determining the performance enhancement function(s) to apply based on at least one previously input specification and the type of the target system. For example, the performance enhancement function applied may be based on whether the target system is a storage system or a web-based search engine.

In one embodiment, determining the performance enhancement function(s) may include determining traffic shaping instruction(s) to apply to the received requests. In one embodiment, the traffic shaping instruction(s) may be based on the unit or subunit of the storage system to which each of the requests is directed. Determining traffic shaping instructions may also include basing the traffic shaping instructions on the performance of the unit of the storage system to which each of the requests is directed. In one embodiment, the traffic shaping instructions may include determining traffic shaping instructions based on the origination of the requests.

In one embodiment, the controller 220 may include a performance model. In a performance model, target or estimated request rate, response time, or utilization level may be determined or set, or a combination of more than one of these may be used. For example, in one embodiment, a QoS goal may include a specification that a certain LU of a storage target system 106 achieve no more than 50% utilization on the disks it is placed on. A performance model may be used to determine whether that level is being achieved, thereby eliminating the need to have explicit performance information made available, since such performance information is often difficult to acquire, or not readily available. In another embodiment, the performance model may include a specification that the maximum predicted response time of a LU of the storage target system 106 is never larger than 20 milliseconds.

In another embodiment, the controller 220 may keep track of which of its instructions better achieve the goals it is attempting to meet, and preferentially select instructions in future situations based on this information.

At step 430, the request processing module 230 may forward the request to the storage system in accordance with the traffic shaping instructions determined by controller 220, or by any other control mechanism, including, but not limited to, request modification, request reordering, dropping or discarding. The requests may be forwarded using rate control or response throttling, or by any other control mechanism, including, but not limited to, request modification, request reordering, dropping or discarding. Forwarding the requests may include forwarding the requests to a predetermined LU of the storage target system 106, or to a different LU, or to a different target system 106.

The method described with reference to FIG. 4 may further include performing LU aggregation, LU security, request merging, splitting, or coalescing, and local or remote replication (“mirroring”).

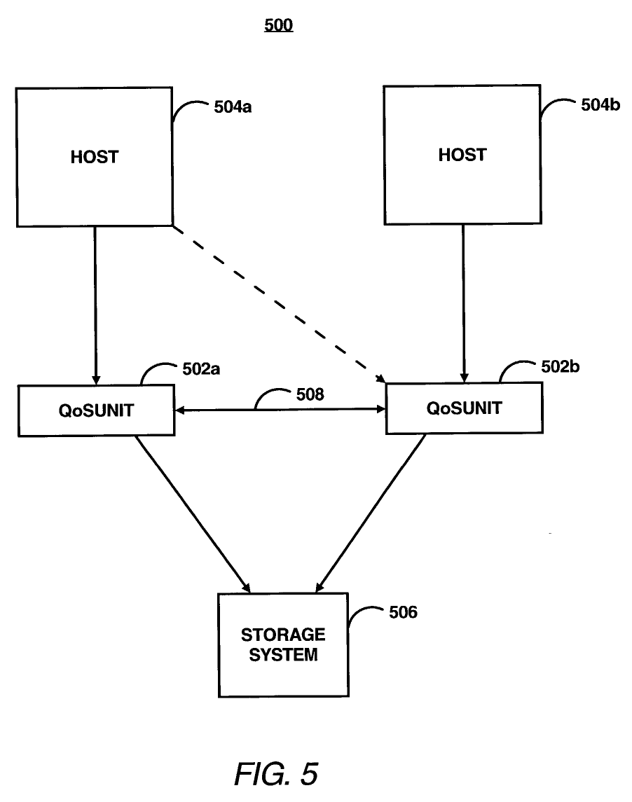

FIG. 5 is a block diagram illustrating a second embodiment of the system for enforcing storage system guarantees. System 500 may include client systems 504a, 504b, QoS unit1 502a, QoS unit2 502b and target system 506. In this embodiment, two or more QoS units for 502a, 502b collaborate to provide access to the target system 506. They may do this in order to increase the availability of the system 506 (if one QoS unit fails, the other can continue in operation), or to increase the load that the QoS units 502a, 502b can handle, or both. There may be more than two QoS units 502a, 502b cooperating in this fashion. The units can be in more than one geographic location, or otherwise configured to permit enhanced failure tolerance.

For example, there may be sets of QoS units 502a, 502b that cooperate in arbitrary ways to coordinate access to the back-end resources or services, and the allocation of work to the QoS units may be as flexible as is desired. Any known technique may be applied to achieve the distribution of responsibilities between them, including both static and dynamic partitioning of work.

QoS units 502a, 502b may communicate amongst themselves to share load information. This sharing may be performed in any of a number of ways. The QoS unit1 502a and QoS unit2 502b may be connected together through a storage area network fabric, through a dedicated network, or through an existing network infrastructure such as a LAN or part of the site wide LAN. The connection 508 may be used to share information about loads coming to the back end devices, such as back end storage devices of system 506, from multiple sources 504a, 504b. Thus, for example, client 504a may transmit a request that is intercepted or received by QoS unit1 502a and transmitted to system 506.

The information about the shared load may be instantaneous (i.e., it is communicated soon as it is known), or it may be approximate (e.g., by being delayed and time-averaged, or smoothed, before it is transmitted). The individual QoS units may choose to make decisions about traffic shaping that take into account the shared information, or not, and they may choose to weight the local information differently from the received load information.

The information shared between QoS units may include additional information, such as information about which traffic shaping techniques have proven effective, and this information may be used by the QoS units to enhance their own performance.

QoS unit2 502b may also receive a request from client 504a through a secondary access path. The use of two or more QoS units 502a, 502b allows fault tolerance in the traffic shaping function performed by QoS units 502a, 502b. In another embodiment, fault tolerance may be achieved by a single QoS unit 502a constructed from internally redundant components and engineered to be at least as reliable as the target system 506 that it is policing.

By imposing a storage-smart traffic shaper function at the front end of the shared target system 506, all access to the system 506 may be monitored and, if necessary, modified to ensure that too much load is not imposed on the system 506 to prevent guarantees from being met. For example, the type of traffic shaping may be adjusted to handle the implications of the applied load on the underlying storage system 506.

The method described above with respect to FIG. 4 may be compiled into computer programs (e.g., software in QosUnit1 502a, QosUnit2 502b in FIG. 5). These computer programs can exist in a variety of forms both active and inactive. For example, the computer program can exist as software comprised of program instructions or statements in source code, object code, executable code or other formats. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While this invention has been described in conjunction with the specific embodiments thereof, it is evident that many alternatives, modifications and variations will be apparent to those skilled in the art. These changes and others may be made without departing from the spirit and scope of the invention.

What is claimed is:

1. A method for enforcing system performance guarantees, comprising:
receiving one or more requests for access to a target system;
determining at least one performance related function, based on at least one previously input specification and type of the target system, to apply to the one or more requests; and
forwarding the one or more requests to the target system in accordance with the at least one performance related function.

2. The method of claim 1, wherein forwarding the one or more requests in accordance with the at least one performance related function comprises performing at least one of rate control and response throttling.

3. The method of claim 2, wherein performing response throttling comprises changing a rate at which requests are forwarded until the rate at which requests are forwarded reaches a predetermined level.

4. The method of claim 1, wherein forwarding the one or more requests to the target system comprises forwarding each of the one or more requests to a predetermined unit of one or more units of the target system.

5. The method of claim 4, wherein determining the at least one performance related function comprises determining the at least one performance related function based on at least one of the unit of the target system to which the each of the one or more requests are directed, performance of the unit of the target system to which each of the requests are directed and the origination of the one or more requests.

6. The method of claim 1, wherein receiving the one or more requests comprises intercepting requests from a network to the target system.

7. The method of claim 1, further comprising performing at least one of logical unit aggregation, logical unit security, local replication and remote replication on the requests.

8. The method of claim 1, wherein the at least one performance related function comprises traffic shaping.

9. The method of claim 1, further comprising performing at least one of breaking up the one or more requests into two or more smaller requests, merging two or more of the one or more requests, coalescing two or more of the one or more requests, and reconstituting the one or more requests.

10. The method of claim 1, wherein the at least one previously input specification includes at least one of performance enhancement specifications, performance enhancement goals, target system specifications and target system goals.

11. A system for enforcing system performance guarantees, comprising:
means for receiving one or more requests for access to a target system;
means for determining at least one performance related function, based on at least one previously input specification and type of the target system, to apply to the one or more requests; and
means for forwarding the one or more requests to the storage system in accordance with the at least one performance related function.

12. The system of claim 11, wherein the means for forwarding the one or more requests in accordance with the at least one performance related function comprises means for performing at least one of rate control and response throttling.

13. The system of claim 12, wherein the means for performing response throttling comprises means for changing a rate at which requests are forwarded until the rate at which requests are forwarded reaches a predetermined level.

14. The system of claim 11, wherein the means for forwarding the one or more requests to the target system comprises means for forwarding each of the one or more requests to a predetermined unit of one or more units of the target system.

15. The system of claim 14, wherein the means for determining the at least one performance related function comprises means for determining the at least one performance related function based on at least one of the unit of the target system to which the each of the one or more requests are directed, performance of the unit of the storage system to which each of the requests are directed and the origination of the one or more requests.

16. The system of claim 11, wherein the means for receiving the one or more requests comprises means for intercepting requests from a network to the target system.

17. The system of claim 11, further comprising means for performing at least one of logical unit aggregation, logical unit security, local replication and remote replication on the requests.

18. The system of claim 11, wherein the at least one performance related function comprises traffic shaping.

19. The system of claim 11, further comprising means for performing at least one of breaking up the one or more requests into two or more smaller requests, merging two or more of the one or more requests, coalescing two or more of the one or more requests, and reconstituting the one or more requests.

20. The system of claim 11, wherein the means for receiving the requests to the target system, the means for determining the at least one performance related function and the means for forwarding the one or more requests reside in software executing on one of a quality of service unit, a fabric switch, a disk array, a data tower, a data mover engine, a host bus adapter and a RAID controller card.

21. The system of claim 11, wherein the at least one previously input specification includes at least one of performance enhancement specifications, performance enhancement goals, target system specifications and target system goals.

22. A performance enhancement unit coupled to a target system, comprising:
a controller for determining at least one performance related function to apply to one or more requests, based on at least one previously input specification and type of target system to which the requests are directed; and
a request processing unit to receive the one or more requests from a client, perform the at least one performance related function and transmit the one or more requests to a target system.

23. The performance enhancement unit of claim 22, wherein the at least one previously input specification includes at least one of performance enhancement specifications, performance enhancement goals, target system specifications, and target system goals.

24. The performance enhancement unit of claim 22, wherein the request processing unit performs at least one of rate control, response throttling, logical unit aggregation, logical unit security, local replication and remote replication, breaking up the one or more requests into two or more smaller requests, merging two or more of the one or more requests, coalescing two or more of the one or more requests, and reconstituting the one or more requests.

25. A performance enhancement system comprising:
a target system coupled to a network; and
one or more performance enhancing units for receiving one or more requests for access to the target system, determining performance enhancement functions to apply to the one or more requests, based on at least one previously input specification and type of the target system, and forwarding the requests to the target system in accordance with the performance enhancement functions.

26. The system of claim 25, wherein the one or more performance enhancement units comprise at least two performance enhancement units, and a client system transmits requests to the at least two performance enhancement units.

27. The system of claim 25, wherein the one or more performance enhancement units comprise at least two performance enhancement units, and information regarding requests received by the at least two performance enhancement units is shared by the at least two performance enhancement units for determining the performance enhancement functions.

28. A computer readable storage medium on which is embedded a computer program comprising a method for enforcing storage system performance guarantees, the method comprising:
receiving one or more requests for access to a target system;
determining at least one performance related function, based on at least one previously input specification and type of the target system, to apply to the one or more requests; and
forwarding the one or more requests to the storage system in accordance with the at least one performance related function.

29. A method for enforcing system performance guarantees, comprising:
receiving one or more requests for access to a target system;
determining at least one performance related function, based on at least one previously input specification and type of the target system, to apply to the one or more requests, the target system comprising at least one of a storage system, a web-based search engine, a web site, and an information search service; and
forwarding the one or more requests to the target system in accordance with the at least one performance related function.

30. The method of claim 29, wherein forwarding the one or more requests in accordance with the at least one performance related function comprises performing at least one of rate control and response throttling.

31. The method of claim 30, wherein performing response throttling comprises changing a rate at which requests are forwarded until the rate at which requests are forwarded reaches a predetermined level.

32. The method of claim 29, wherein forwarding the one or more requests to the target system comprises forwarding each of the one or more requests to a predetermined unit of one or more units of the target system.

33. The method of claim 32, wherein determining the at least one performance related function comprises determining the at least one performance related function based on at least one of the unit of the target system to which the each of the one or more requests are directed, performance of the unit of the target system to which each of the requests are directed and the origination of the one or more requests.

34. The method of claim 29, wherein receiving the one or more requests comprises intercepting requests from a network to the target system.

35. The method of claim 29, further comprising performing at least one of logical unit aggregation, logical unit security, local replication and remote replication on the requests.

36. The method of claim 29, wherein the at least one performance related function comprises traffic shaping.

37. The method of claim 29, further comprising performing at least one of breaking up the one or more requests into two or more smaller requests, merging two or more of the one or more requests, coalescing two or more of the one or more requests, and reconstituting the one or more requests.

38. The method of claim 29, wherein the at least one previously input specification includes at least one of performance enhancement specifications, performance enhancement goals, target system specifications and target system goals.

39. A system for enforcing system performance guarantees, comprising:
means for receiving one or more requests for access to a target system;
means for determining at least one performance related function, based on at least one previously input specification and type of the target system, to apply to the one or more requests, the target system comprising at least one of a storage system, a web-based search engine, a web site, and an information search service; and
means for forwarding the one or more requests to the storage system in accordance with the at least one performance related function.

40. The system of claim 39, wherein the means for forwarding the one or more requests in accordance with the at least one performance related function comprises means for performing at least one of rate control and response throttling.

41. The system of claim 40, wherein the means for performing response throttling comprises means for changing a rate at which requests are forwarded until the rate at which requests are forwarded reaches a predetermined level.

42. The system of claim 39, wherein the means for forwarding the one or more requests to the target system comprises means for forwarding each of the one or more requests to a predetermined unit of one or more units of the target system.

43. The system of claim 42, wherein the means for determining the at least one performance related function comprises means for determining the at least one performance related function based on at least one of the unit of the target system to which the each of the one or more requests are directed, performance of the unit of the storage system to which each of the requests are directed and the origination of the one or more requests.

44. The system of claim 39, wherein the means for receiving the one or more requests comprises means for intercepting requests from a network to the target system.

45. The system of claim 39, further comprising means for performing at least one of logical unit aggregation, logical unit security, local replication and remote replication on the requests.

46. The system of claim 39, wherein the at least one performance related function comprises traffic shaping.

47. The system of claim 39, further comprising means for performing at least one of breaking up the one or more requests into two or more smaller requests, merging two or more of the one or more requests, coalescing two or more of the one or more requests, and reconstituting the one or more requests.

48. The system of claim 39, wherein the means for receiving the requests to the target system, the means for determining the at least one performance related function and the means for forwarding the one or more requests reside in software executing on one of a quality of service unit, a fabric switch, a disk array, a data tower, a data mover engine, a host bus adapter and a RAID controller card.

49. The system of claim 39, wherein the at least one previously input specification includes at least one of performance enhancement specifications, performance enhancement goals, target system specifications and target system goals.

50. A performance enhancement unit coupled to a target system, comprising:
a controller for determining at least one performance related function to apply to one or more requests, wherein the performance related function is based on at least one previously input specification and type of target system to which the requests are directed; and
a request processing unit to receive the one or more requests from a client, perform the at least one performance related function and transmit the one or more requests to a target system, the target system comprises at least one of a storage system, a web-based search engine, a web site, and an information search service.

51. The performance enhancement unit of claim 50, wherein the at least one previously input specification includes at least one of performance enhancement specifications, performance enhancement goals, target system specifications and target system goals.

52. The performance enhancement unit of claim 50, wherein the request processing unit performs at least one of rate control, response throttling, logical unit aggregation, logical unit security, local replication and remote replication, breaking up the one or more requests into two or more smaller requests, merging two or more of the one or more requests, coalescing two or more of the one or more requests, and reconstituting the one or more requests.

53. A performance enhancement system comprising:
a target system coupled to a network, the target system comprising at least one of a storage system, a web-based search engine, a web site, and an information search service; and
one or more performance enhancing units for receiving one or more requests for access to the target system, determining performance enhancement functions to apply to the one or more requests, wherein the performance related function is based on at least one previously input specification and type of the target system, and forwarding the requests to the target system in accordance with the performance enhancement functions.

54. The system of claim 53, wherein the one or more performance enhancement units comprise at least two performance enhancement units, and a client system transmits requests to the at least two performance enhancement units.

55. The system of claim 53, wherein the one or more performance enhancement units comprise at least two performance enhancement units, and information regarding requests received by the at least two performance enhancement units is shared by the at least two performance enhancement units for determining the performance enhancement functions.

56. A computer readable storage medium on which is embedded a computer program comprising a method for enforcing storage system performance guarantees, the method comprising:
receiving one or more requests for access to a target system;
determining at least one performance related function, based on at least one previously input specification and type of the target system, to apply to the one or more requests, wherein the target system comprises at least one of a storage system, a web-based search engine, a web site, and an information search service; and
forwarding the one or more requests to the storage system in accordance with the at least one performance related function.
